(19) United States
(12) Patent Application Publication
(10) Pub. No.: US 2007/0112485 A1
(43) Pub. Date: May 17, 2007

(54) Vehicle service device and system powered by capacitive power source

(75) Inventors: Steven W. Rogers, Conway, AR (US); Adam C. Brown, Maumelle, AR (US); Eric F. Bryan, Conway, AR (US)

Correspondence Address: MCDERMOTT WILL & EMERY LLP, 600 13TH STREET, N.W., WASHINGTON, DC, 20005-3096, US

(73) Assignee: SNAP-ON INCORPORATED

(21) Appl. No.: 11/280,467

(22) Filed: Nov. 17, 2005

(51) Int. Cl. G01M 17/00; G01C 1/00

(52) U.S. Cl. 701/29; 356/139.09

(57) ABSTRACT

A vehicle service device configured to be powered by a capacitive power source positioned in the service device.

### FIELD OF DISCLOSURE

This disclosure relates to vehicle service devices and systems that are powered by capacitive power sources.

### BACKGROUND OF THE DISCLOSURE

In an effort to eliminate the need for electrical cords to draw power from electrical outlets, many vehicle service systems or devices, such as vehicle diagnostic systems, alignment systems, etc., are powered by disposable or rechargeable batteries. The elimination of electrical cords provides an easier system setup and less-obstructive working environment.

However, using batteries to power vehicle service devices and systems have various drawbacks. Rechargeable batteries have a life span of only several hundred charge and discharge cycles. The cost for replacing the batteries is high. In addition, disposal of old batteries poses an environmental hazard, and therefore requires a special, and sometimes costly, disposal process or service. Moreover, it usually takes several hours to fully charge the batteries before they can be used. Thus, multiple sets of batteries are needed to avoid interruption of operations. Furthermore, batteries are vulnerable to improper charging operations. Over charging or charging at elevated temperatures can dramatically shorten the battery life.

Consequently, there is a need to provide vehicle service devices and systems with a power source that needs very little time to reenergize. There is also a need of a vehicle service device and system that are portable and cordless, but do not cause environmental hazards such as those powered by batteries.

### SUMMARY OF THE DISCLOSURE

Various embodiments are disclosed relating to vehicle service devices and systems that are powered by capacitive power sources. Examples of vehicle service devices/systems include an alignment head configured to collect wheel parameters, a device configured to access data stored in a vehicle, a device configured to load data to an on-board computer of a vehicle, a device configured to measure signals of a component of a vehicle, a device configured to download data related to vehicle services, a non-contact sensor module configured to obtain wheel parameters or vehicle body parameters in a non-contact manner, a tool for servicing vehicles, etc.

An exemplary vehicle service device of this disclosure includes a capacitive power storage unit that is positioned in or attached to the device and provides sufficient power for the operation of the vehicle service device. The capacitive power storage unit may be detached from the vehicle service device.

In one embodiment, the capacitive power storage unit is charged by an power supply external to the vehicle service device. The vehicle service device may include a coupling apparatus, such as connectors, for coupling to the external power supply to receive power therefrom. In another aspect, the capacitive power storage unit receives power from an external power supply in a non-contact manner, such as by inductive charging. A portable power supply may be used to charge the capacitive power storage unit. The portable power supply includes a portable power source and coupling means for coupling to the vehicle service device or the capacitive power storage unit. The portable power source charges the capacitive power storage unit when the portable power supply is coupled to the vehicle service device or the capacitive power storage unit. The portable power source may be a battery pack, a portable DC power supply drawing power from an electrical outlet, another capacitive power storage unit, etc., or any combinations thereof.

In one embodiment, a docking device is provided for receiving the vehicle service device or the capacitive power storage unit. Responsive to the vehicle service device or the capacitive power storage unit being received in the docking device, an electrical coupling is formed between the external power supply and the capacitive power storage unit of the vehicle service device. The external power supply charges the capacitive power storage unit via the electrical coupling. In another embodiment, responsive to the vehicle service device or the capacitive power storage unit being received in the docking device, a data channel is formed between the docking device and the vehicle service device or the capacitive power storage unit, for retrieving data from, and/or sending data to, the vehicle service device or the capacitive power storage device via the data channel.

According to another embodiment, an alignment system comprises a vehicle service device configured to obtain alignment parameters of a vehicle, and a data processing system configured to receive the obtained alignment parameters and to determine an alignment status of the vehicle based on the alignment parameters. The vehicle service device is powered by a capacitive power storage unit positioned in or attached to the service device. The capacitive power storage unit may be detached from the vehicle service device.

The service device may include an optical sensor, such as a camera, to generate the alignment parameters by imaging at least one wheel of the vehicle or a target attached thereto. According to another embodiment, the service device is attachable to a wheel of the vehicle for collecting alignment parameters. The service device may communicate with the data processing system in a wireless manner, such as by using a wireless link or wireless network link, such as 802.11, Bluetooth, GSM, etc.

The alignment system may further include an external power supply for charging the capacitive power storage unit of the vehicle service device. The external power supply may be a portable power storage unit that charges the capacitive power storage unit of the vehicle service device when the capacitive power supply unit is coupled to the vehicle service device. A docking device may be provided for receiving the vehicle service device or the capacitive power storage unit. When the vehicle service device or the capacitive power storage unit is received in the docking device, an electrical coupling is established for charging the capacitive power storage unit. The docking device may be configured to receive and charge the external power supply.

Additional advantages and novel features of the present disclosure will be set forth in part in the description which follows, and in part will become apparent to those skilled in the art upon examination of the following, or may be learned by practice of the present disclosure. The embodiments shown and described provide an illustration of the best mode contemplated for carrying out the present disclosure. The disclosure is capable of modifications in various obvious respects, all without departing from the spirit and scope thereof. Accordingly, the drawings and description are to be regarded as illustrative in nature, and not as restrictive. The advantages of the present disclosure may be realized and attained by means of the instrumentalities and combinations particularly pointed out in the appended claims.

### BRIEF DESCRIPTION OF THE DRAWINGS

The present disclosure is illustrated by way of example, and not by way of limitation, in the accompanying drawings, wherein elements having the same reference numeral designations represent like elements throughout.

FIG. 1 shows an exemplary wireless alignment system.

FIG. 2 depicts an exemplary alignment head according to this disclosure.

FIG. 3 illustrates a block diagram of an exemplary capacitive power storage unit.

FIG. 4 shows an exemplary configuration for replenishing a capacitive power storage unit.

FIG. 5 shows another exemplary configuration for replenishing a capacitive power storage unit.

FIG. 6 shows a power supply including a primary power source and a secondary capacitive power storage unit.

FIG. 7 depicts a camera-based alignment system having a left measurement module and a right measurement module.

### DETAILED DESCRIPTIONS OF ILLUSTRATIVE EMBODIMENTS

For illustration purpose, the following descriptions describe various illustrative embodiments of a vehicle service device/system powered by a capacitive power storage unit. It will be apparent, however, to one skilled in the art that concepts of the disclosure may be practiced or implemented without these specific details. In other instances, well-known structures and devices are shown in block diagram form in order to avoid unnecessarily obscuring the present disclosure.

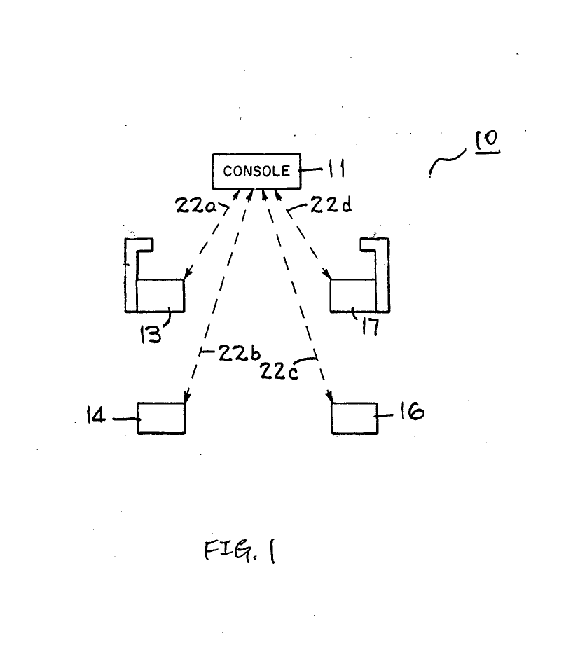

FIG. 1 shows an exemplary wireless alignment system 10 embodying the concepts of this disclosure. Wheel alignment heads 13 (left front), 14 (left rear), 16 (right rear) and 17 (right front) are detachably mounted to wheels of a vehicle under test, and at least one of the alignment heads is powered by a capacitive power storage unit. These alignment heads are used to measure various angles of vehicle wheels and/or suspension, such as toe, caster and camber. Infrared transmitters and receivers are included in the alignment heads, to provide wireless communications between the alignment heads 13, 14, 16 and 17 and a console system 11. The console system 11 includes a data processing system, such as a computer, to process signals received from the alignment heads.

According to one embodiment, each alignment head, as illustrated in FIG. 1, communicates with the console system 11 via a respective wireless link 22a, 22b, 22c and 22d. According to another embodiment, more than one alignment head shares a wireless link to communicate with the console system 11. Descriptions of wireless alignments systems are provided in U.S. Pat. No. 4,761,749, titled “Vehicle Wheel Alignment Apparatus and Method,” and U.S. Pat. No. 5,592,383, titled “Wheel Aligner Cordless Communications Unit,” the disclosures of which are incorporated herein by reference in their entireties.

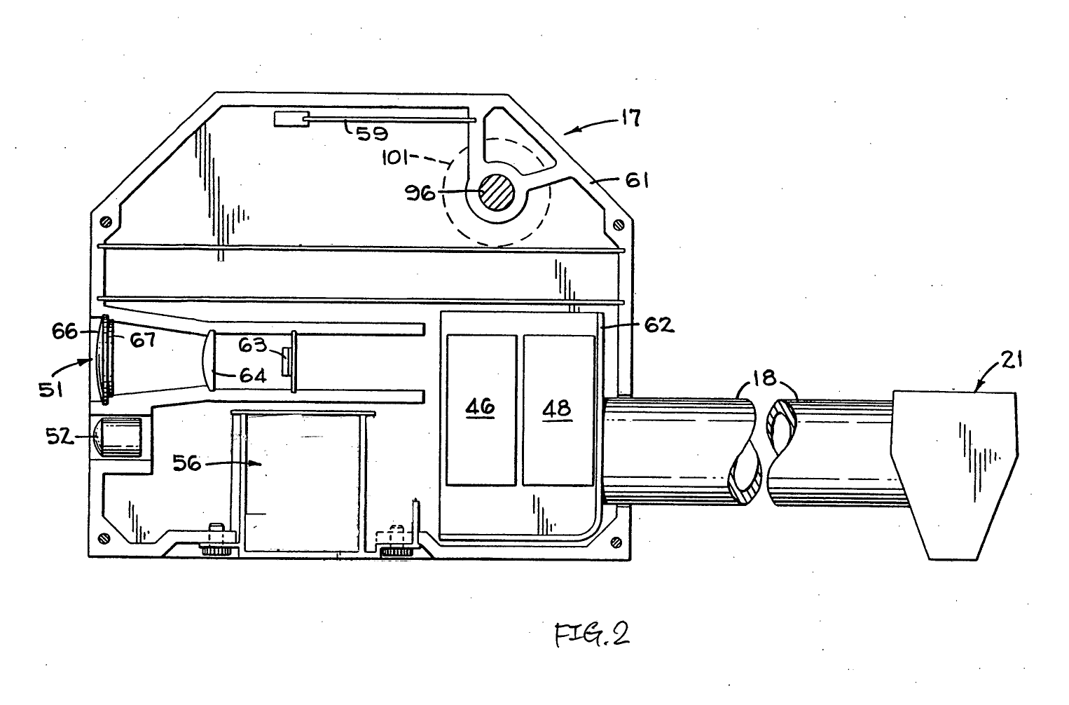

FIG. 2 depicts an exemplary alignment head 17 used in the alignment system 10, as illustrated in FIG. 1. Housing 61 encloses parts and components of alignment head 17. A bracket 62 is secured within the housing 61, upon which is welded to a boom tube 18 as well as a camber inclinometer 46 and a steering axis inclination inclinometer 48. The boom tube 18 is connected to a cross toe transceiver. A rearwardly directed array of infrared light emitting diodes (LEDs) 63 is shown projecting infrared or light energy toward a cylindrical lens 64. The array of LEDs is about twenty to thirty in number. The cylindrical lens 64 causes LED light dispersion in a substantially vertically disposed direction. The light from the cylindrical lens 64 is projected toward a plano-convex lens 66 which functions to focus the vertically dispersed light as light stripes within the range of vehicle wheel bases for which the alignment system is designed, and therefore to focus the stripes at approximately the distance occupied by a rear wheel mounted alignment head receiver.

A pair of prisms 67 is attached to the planar side of lens 66 to obtain a ten degree beam deflection of the LED light stripes. The prisms 67 therefore have a deviating or refracting power of ten degrees to thereby form vertical beams identical to the beams which pass through the center of the plano-convex lens 66 except that they are deflected ten degrees from the beam passing through the plano-convex lens alone. In this fashion a vertical light stripe pattern may be projected about a centerline extending substantially straight rearwardly from the wheel mounted alignment head as well as two additional patterns arrayed about centerlines substantially ten degrees to either side of the central array. The two additional angularly disposed arrays are used in determining front wheel steering angle in the processes to be described hereinafter and are not generated in the rear wheel mounted alignment heads. The assembly of items 63, 64, 67 and 66 (and appropriate mounting and adjustment structure) forms the rearwardly directed infrared light transmitter 51. The housing 61 of the alignment head 17 also includes support structure for the rearward looking infrared receiver 52 so that reflected light from transmitter 51 or light transmitted from a rear mounted alignment head may be received thereby.

The alignment head 17 further includes a circuit board 59 carrying electronic components that are needed to process, convert and/or store signals obtained by the alignment head 17, and to form a wireless link 22d with the console system 11 to transmit and/or receive data. The alignment head 17 is powered by a capacitive power storage unit 56. Unlike batteries that generate power by chemical reactions, the capacitive power storage unit 56 is a capacitive power bank retaining energy by charge separations and having a high energy density. The energy retained by the capacitive storage unit 56 is of a sufficient level needed for the operation of the alignment head 17. In one embodiment, a type of high-energy capacitive devices, called supercapacitors, ultracapacitors or aerogel supercapacitors, are used to implement the capacitive power storage unit 56. For description purpose, these names of capacitive devices are used interchangeably throughout this disclosure. Examples of high-energy capacitive devices that may be used to implement the capacitive power storage unit 56 include Booscap® Ultracapacitors offered by Maxell Technologies of San Diego, Calif., and PowerStor® supercapacitors by Cooper Electronic Technologies of Boynton Beach, Fla.

Ultracapacitors with similar or different capacities and/or ratings can be interconnected in series or parallel or a combination of both, to provide desired power rating and/or capacity. Since the energy is retained as an electrical charge on capacitive plates instead of ions in the reactive chemistry of a battery, energy can be replenished in a matter of seconds as opposed to the hours of recharge time required for a battery. Also, these capacitive devices can be replenished and reused for hundreds of thousands of cycles and may have a life span that is 5 to 10 times longer than that of typical batteries.

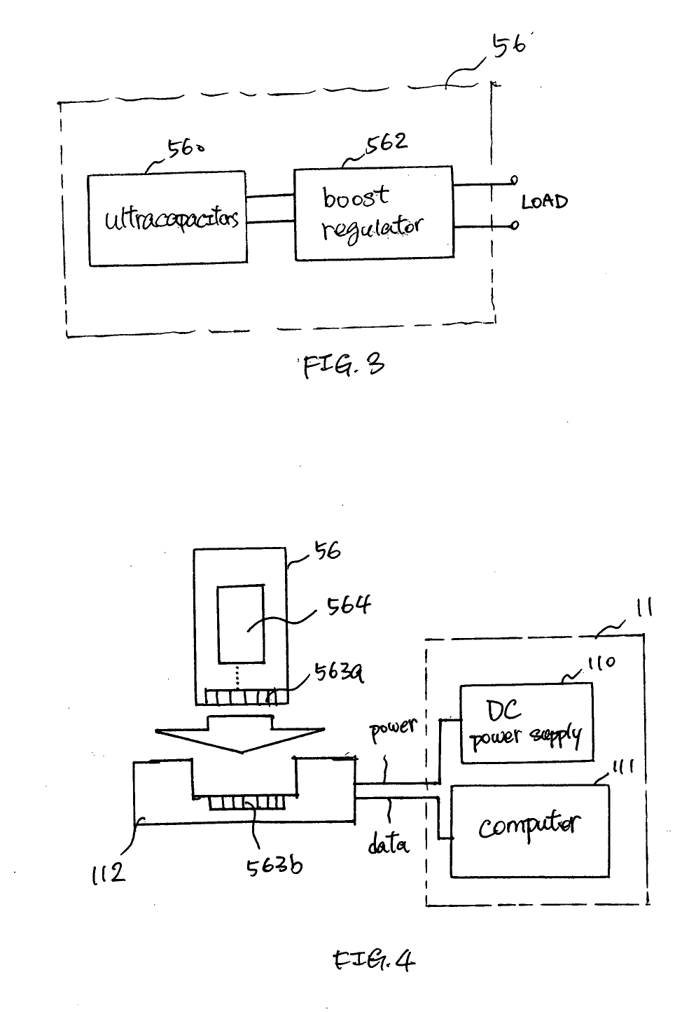

FIG. 3 shows a block diagram of an exemplary capacitive power storage unit 56. The capacitive power storage unit 56 includes ultracapacitors 560 coupled to a boost regulator 562. The boost regulator 562 regulates and stabilizes the power output by the ultracapacitors 560 and boosts the output voltage to a level required by the load (such as the circuits in the alignment head 17).

According to one embodiment of this disclosure, the operation voltage of the alignment head 17 is set at between 1.5 to 2.5 volts, with an operating current of 0.25 Amps. In order to continuously provide sufficient power to the alignment head 17 for a period of 60 minutes, the capacitive power storage unit 56 includes 18 PowerStor® aerogel supercapacitors connected in parallel. Each supercapacitor has a capacity of 50 farads, with resistance of 0.0025 Ohms and a maximum voltage output of 2.5 volts. Therefore, the capacitive power storage unit 56 has a total capacitance of 900 farads.

The following calculations may be used to determine appropriate sizes of ultracapacitors for a specific application. An ultracapacitor's voltage profile (voltage vs. time) includes two components: a capacitive component and a resistive component. The capacitive component represents a voltage change due to the change in energy within the ultracapacitor. The resistive component represents a voltage change due to the equivalent series resistance (ESR) of the ultracapacitor.

The capacitive component is governed by the equation:

$$i = C * \frac{ⅆ V}{ⅆ t} \qquad equation ( 1 )$$

Where:
i=current
C=capacitance
dV=change in voltage
dt=change in time (time of discharge)

Rearranging equation (1) and solving for dV:

$$d V = i * \frac{d t}{C} \qquad equation ( 2 )$$

The resistance component is governed by equation (3):
V=i*R equation (3)
Where:
V=voltage drop across the resistor
i=current
R=equivalent series resistance

The total voltage change when charging or discharging an ultracapacitor includes both of these components. Combining the capacitive and resistive components in equations (2) and (3):

$$d V = i * \frac{d t}{C} + i * R \qquad equation ( 4 )$$

dV=the change in voltage during the discharge of the capacitor. This is determined by knowing the working operating voltage (V_{W}), and the minimum allowable system voltage (Vₘᵢₙ). V_{W} should be the typical operating voltage at the beginning of a discharge. In some cases, this will be the maximum voltage of the system (Vₘₐₓ), but in other cases it will not.
i=the current during the discharge of the capacitor. This calculation assumes a constant current during the discharge
dt=the duration of the discharge pulse.
C=the capacitance of the capacitive power storage unit 56 at its operating point. This value will be based on the number of individual capacitors in series or parallel. For ultracapacitors in parallel, the capacitance is additive. For ultracapacitors in series, the capacitance is additive at 1/capacitane. The capacitance will also be affected by the duration of the pulse.

$${C}_{total} = {C}_{cell} * \frac{\# parallel}{\# series} \qquad equation ( 5 )$$

To determine how many cells are required in series, divide the maximum application voltage Vₘₐₓ by the maximum allowable cell voltage. The maximum allowable cell voltage is determined by life and temperature considerations. Nominally, this can be assumed to be 2.5 volts per cell.

The number of cells in parallel is determined after the first iteration of this calculation. If the first iteration indicates that there is inadequate capacitance for the application's requirements, the capacitance and resistance can be changed by either putting more cells in parallel or by using larger cells. In some instances, using fewer series cells and choosing to operate the individual cells at higher voltages is an option. This is a trade-off of performance vs. life, since higher operating voltages decrease life. This trade-off must be done on a case-by-case basis.
R=the resistance of the capacitive power storage unit 56. This value will be based on the number of individual capacitors in series or parallel. The greater the number of cells in parallel, the lower the resistance. The greater number of cells in series, the greater the resistance. Note that this is the opposite of how capacitance is calculated. The resistance will also be affected by the duration of the pulse.

$${R}_{total} = {R}_{cell} * \frac{\# series}{\# parallel} \qquad equation ( 6 )$$

In analyzing any application, the system variables need to be obtained, in order to determine the value of the variables required to solve equation (4). Therefore, the following information about the application needs to be gathered:
Vₘₐₓ=maximum voltage
V_{W}=working operating voltage
Vₘᵢₙ=minimum allowable voltage current requirement
I=current requirement
   Or
P=power requirement
t=time of discharge (or charge)

Sizing Based on a Known Ultracapacitor Size

Assuming that a power storage unit configured to supply 10 kilowatts (kW) for 5 seconds, the unit will normally operate at 56 volts, and can function on a voltage as low as 25 volts. The system will never experience greater than 60 volts.

Step 1: Determine Basic System Parameters
Vₘₐₓ=60 volts
V_{W}=56 volts
Vₘᵢₙ=25 volts
Power=10 kW
time=5 seconds

Step 2: Determine the Values of the Variables in Equation #4
dV=V_{W}−Vₘᵢₙ=56−25=31 volts
i=average current
iₘₐₓ=Power/Vₘᵢₙ=10,000 watts/25 volts=400 amps
iₘᵢₙ=Power/Vₘₐₓ=10,000 watts/56 volts=179 amps
i_{avg}=(400+179)/2=289 amps
i=289 A
dt=5 sec
C=total stack capacitance

Vₘₐₓ is defined as 60 volts. The required number of cells in series is determined by dividing Vₘₐₓ by the cell voltage:
Vₘₐₓ=60 volts
Cell voltage=2.5 volts
number of cells needed=60 volts/2.5 volts=24 series
From equation 5,

$${C}_{total} = {C}_{cell} * \frac{\# parallel}{\# series} \qquad equation ( 5 )$$
Cell capacitance=1800 F (for a BCAP008)
# parallel—1 (initially a single string)
# series=24
total stack capacitance=1800 F/24=75 F
C=75 F
R=total stack resistance.
From equation 6,

$${R}_{total} = {R}_{cell} * \frac{\# series}{\# parallel} \qquad equation ( 6 )$$
Cell resistance=0.0006 ohm (for a BCAP0008)
# series=24
total stack resistance=0.0006 ohm*24=0.0144 ohm

Having all the variables defined, we can solve for the change in voltage (dV), or for duration (dt). Solving for a given change in voltage allows us to see how much margin we have on time. Solving for a given duration allows us to see how much margin we have on voltage. Since equation 4 is already solved for dV, we will proceed in that direction.

$$d V = i * \frac{d t}{C} + i * R$$

Substituting in the values for i, dt, C, and R;
dV=289 A*5 sec/75 F+289 A*0.0144 ohm=23.4 volts

Sizing Based on an Unknown Ultracapacitor Size (Finding the Optimum Size)

An alternative method to size a solution is to determine the optimum size which meets the requirements, then adjust based on actual product offerings.

Step 1: Determine Basic System Parameters (Same as Previous Example)
Vₘₐₓ=60 volts
V_{w1}=56 volts
Vₘᵢₙ=25 volts
Power=10 kW
time=5 seconds

Step 2: Determine the Values of the Variables in Equation #4
dV=V_{W}−Vₘᵢₙ=56−25=31 volts
i=average current
iₘₐₓ=Power/Vₘᵢₙ=10,000 watts/25 volts=400 amps
iₘᵢₙ=Power/Vₘₐₓ=10,000 watts/56 volts=179 amps
i_{avg}=400+179)/2=289 amps
i=289 A
dt=5 sec
C=total stack capacitance We will solve for the total stack capacitance.
R=total stack resistance. We will use the RC time constant for determining resistance.
   The RC time constant of an ultracapacitor is the product of its capacitance value and resistance value. For this example, assume an ultracapacitor time constant of 1.1 seconds.
Since R*C=1.1 seconds,
R=1.1/C

Having all the variables defined, rearrange equation #4 and solve for C:
Equation #4 originally:

$$d V = i * \frac{d t}{C} + i * R$$
Substitute R=1.1/C:

$$d V = i \cdot \frac{d t}{C} + i \cdot \frac{1.1}{C}$$
Factor out “i/C”

$$dV = \frac{i}{C} \cdot ( dt + 1.1 )$$
Solving for C

$$C = \frac{i}{dV} \cdot ( dt + 1.1 )$$
Substituting in the variables for dV, I, and dt;
   C=289/31V*(5+1.1)=56.9 F

This value of capacitance is the total stack capacitance. We must now determine the required cell capacitance. From the previous example, the number of series cells needed is 24.
From equation 5,

$${C}_{total} = {C}_{cell} * \frac{\# parallel}{\# series}$$
Setting the number of parallel=1

$${C}_{total} = \frac{{C}_{cell}}{\# series}$$
Solving for C_{cell}
   C_{cell}=Cₜₒₜₐₗ*#series
Stack capacitance=56.9 F
the number of series=24 cells
Cell capacitance=1365 F

Further details for calculating or determining configuration of ultracapacitors needed for a specific application are available in a document titled “How to Determine the Appropriate Size Ultracapacitor for Your Application” by Maxell Technologies, published October 2004.

According to one embodiment, the capacitive power storage unit 56 is designed to be easily detachable from the alignment head 17. For instance, the capacitive power storage unit 56 is packed as a single package that can be inserted into a compartment of the alignment head 17. One or more locking devices, such as latches or other types of securing mechanism, are provided to allow easy and fast detachment of the capacitive power storage unit 56 from the alignment head 17, to allow maintenance, replacement or replenishment of the capacitive power storage unit 56. It is understood by those people skilled in the art that other alignment heads 13, 14 and 16 may be powered in a way similar to the alignment head 17, or by conventional power sources, such as batteries or electrical outlets.

If the capacitive power storage unit 56 runs out of power, it can be replenished in various ways. According to one embodiment, an external power supply, such as a DC power supply, is provided for replenishing the capacitor devices included in the capacitive power storage unit 56. When the capacitive power storage unit 56 runs out of energy, a technician can simply remove the capacitive power storage unit 56 from the alignment head 17 and connect it to the external power supply via suitable connectors and/or wires. The unique capacitive characteristics of the capacitive power storage unit 56 allows the replenishment process to be completed within seconds, in contrast to hours or days needed by a conventional battery pack.

In one embodiment, both the capacitive power storage unit 56 and the external power supply are equipped with compatible coupling means for forming electrical contacts or electrical coupling, so that the capacitive power storage unit 56 connects to the external power supply via the compatible coupling means without the need for additional wiring. Examples of the coupling means include connectors, probe and socket pairs, electrodes, and/or other means known to people skilled in the art.

According to another embodiment, the external power supply includes a docking device for receiving the alignment head 17 or the capacitive power storage device 56, such that power supply can charge the capacitive power storage unit 56. According to still another embodiment, data is transmitted from or loaded to the alignment head 17 or the capacitive power storage unit 56 when the alignment head 17 or the capacitive power storage unit 56 is placed in the docking system. The data transmitted to the alignment head 17 or the capacitive power storage unit 56 includes at least one of software updates, specifications, etc.

When the alignment head 17 or the capacitive power storage device 56 is received in the docking device, an appropriate electrical coupling is formed between the capacitive power storage unit 56 and the docking device, such as by the respective coupling means (contact or non-contact) of the capacitive power storage unit 56 and the docking device, such that a power supply coupled to the docking device can charge the capacitive power storage unit 56.

According to a further embodiment, the alignment head 17 or the capacitive power storage unit 56 recognizes the status of it being placed in a docking device, or the types of docking devices that receive the alignment head 17 or capacitive power storage device 56. For instance, detection means, such as a switch or a sensor, is designed to be triggered by the coupling of a docking device and the alignment head 17 or the capacitive power storage unit 56. Responsive to the coupling, the alignment head 17 or the capacitive power storage unit 56 performs predetermined functions. The types of functions performed may be determined based different operation conditions. For example, a display on the alignment head 17 may display a status of charge of the capacitive power storage unit 56 in the alignment head 17 if a charging process is being performed. The alignment head 17 or the capacitive power storage unit 56 may selectively provide menu selections suitable to the type of docking device to which it is coupling. The devices may identify themselves by sending a unique identification code.

FIG. 4 shows an exemplary configuration for replenishing the capacitive power storage unit 56 using a docking device 112. The capacitive power storage unit 56 includes a non-volatile memory device 564 such as flash memory or mini hard disk drive. During operation, data, signals and/or spatial parameters collected by the alignment head 17 as well as additional operation data, such as specifications, program updates, usage history, test reports, etc., are stored in the memory device 564. The collected data, signals and/or spatial parameters or characteristics include information related to angles, lengths, heights, locations in one or more coordinate systems, relative positions, etc. The data may be used to determine characteristics and/or alignment status of wheels or vehicle body, such as toe, caster, camber, SAI, locations of spindles, symmetries, Ackermann angles, calibration data, etc. Detailed descriptions of exemplary spatial parameters or characteristics of a vehicle are available in U.S. Pat. No. 6,115,927, titled “Measuring Device Primarily for Use with Vehicles,” U.S. Pat. No. 6,608,688, entitled “Wireless Optical Instrument for Position Measurement and Method of Use therefor;” U.S. Pat. No. 5,724,743, entitled “Method and Apparatus for Determining the Alignment of Motor Vehicle Wheels,” and U.S. Pat. No. 5,535,522, entitled “Method and Apparatus for Determining the Alignment of Motor Vehicle Wheels,” the disclosures of which are incorporated herein by reference in their entireties.

As shown in FIG. 4, the console system 11 includes a DC power supply 110 and a computer 111, each of which is connected to the docking device 112 having an opening to receive the capacitive power storage unit 56. When the capacitive power storage unit 56 is attached to, or placed in, the docking device 112, a connector 563a disposed on the capacitive power storage unit 56 forms an electrical connection with a compatible connector 563b disposed on the docking device 112. The electrical coupling between the capacitive power storage unit 56 and the docking device 112 allows the capacitive power storage unit 56 to form a charging path between the DC power supply 110 and a data path coupling to the computer 111 via the wiring of the docking device 112, such that the capacitive power storage unit 56 is charged by the DC power supply 110 and the data stored in the memory device 564 is transmitted to the computer 111. Additional descriptions related to vehicle service devices/systems using docking means are provided in U.S. Pat. No. 5,375,335, ENTITLED “BATTERY MANAGEMENT FOR VEHICLE ALIGNMENT SENSOR,” the disclosure of which is incorporated herein by reference. With the configuration shown in FIG. 4, data obtained by the alignment head 17 is loaded to the console system 11 via the electrical coupling between the capacitive power storage unit 56 and the docking device 112, without requiring wireless communication capabilities on the alignment head 17 and the console system 11. Data may also be loaded to the capacitive power storage unit 56 from any devices or data sources via the docking device 112.

According to one embodiment, the data obtained by the console system 11 includes at least one of a unique identification of the capacitive power storage unit 56 or the alignment head 17; charging parameters, such as temperature, current, voltage, duration, etc.; specifications of the capacitive power storage unit 56 or the alignment head 17; and usage history of the capacitive power storage unit 56, etc. According to another embodiment, the console system 11 selectively modifies charging parameters based on the identification of the capacitive power storage unit 56 or the alignment head 17.

Although FIG. 4 shows that the charging and data communications use two separate paths, the same coupling or connector can be used for both charging and data transmissions. For instance, if a DC current is used to charge the capacitive power storage unit 56, modulations can be used to transmit data signals on the same transmission path in channels having frequencies different from the DC current. The data signals can be filtered out by using appropriate filters corresponding to the frequency channels. According to another embodiment, the charging current and data signals use the same transmission path by properly multiplexing or scheduling the charging current and data transmissions. For example, data transmissions can take place periodically between t0 to t1, t5 to t6, t10 to t11, etc., and charging can be performed during all other times using the same path. According to a further example, appropriate coding and handshaking are utilized to allow charging and data transmissions using the same path. Predetermined signals or headers are used to indicate when a data transmission starts and ends. Charging can be performed when the same path is not used for data transmissions.

According to still another embodiment, the docking device 112 is configured to receive a plurality of capacitive power storage units 56 and/or alignment heads 17 at the same time. In one example, each capacitive power storage unit 56 or alignment head 17 has an independent channel or channels for data transmissions and/or charging. In another example, the same coupling or path is shared by the plurality of capacitive power storage units 56 and/or alignment heads 17 for charging and/or data transmissions. Each capacitive power storage unit 56 or alignment head 17 has a unique ID code, which is accessible by the console system 11 via the coupling to the docking device 112. The console system 11 determines and provides a charging current suitable to each capacitive power storage unit 56 or alignment head 17, based on their respective ID codes. A charging current is coupled only to the capacitive power storage unit 56 or the alignment head 17 corresponding to a specific ID code associated with the charging current. Data communications with the respective capacitive power storage units 56 or alignment heads 17 are performed and discriminated based on the unique identification code associated with each data packet or transmission.

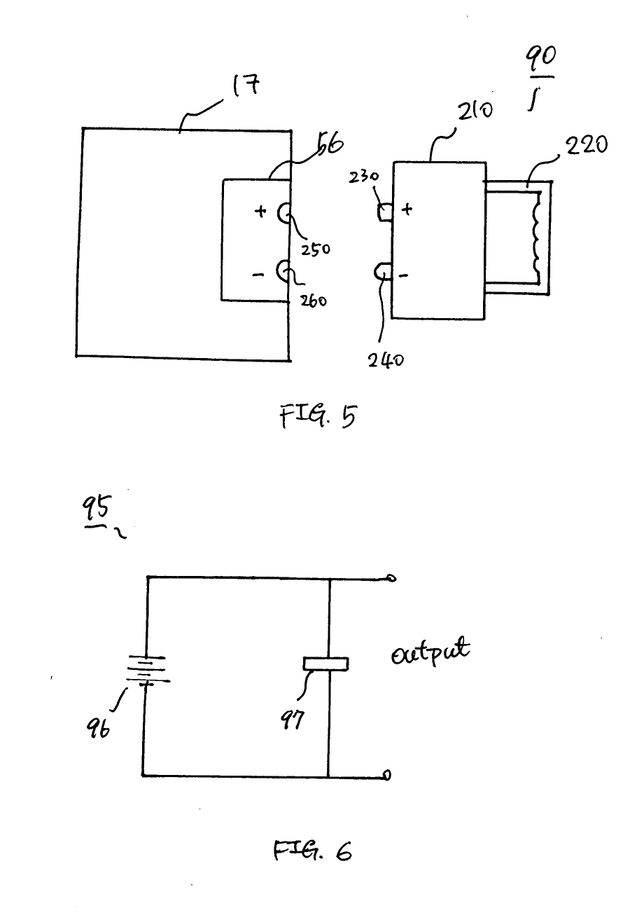

FIG. 5 shows an example for replenishing the capacitive power storage unit 56 using a portable power supply 90. As illustrated in FIG. 5, the capacitive power storage unit 56 includes recessed electrodes 250 and 260. The portable power supply 90 includes a handle 220, a DC power bank 210 and extruding electrodes 230, 240. The extruding electrodes 230, 240 are compatible with the recessed electrodes 250 and 260. Other types or formats of coupling devices known to people skilled in the art can be used to form an electrical coupling between the portable power supply 90 and the capacitive power storage unit 56. The DC power bank may be implemented using any technologies known to people skilled in the art, such as a small-size DC power supply connected to an electric outlet with an electric cord, a battery bank, another capacitive power storage unit, etc., or any combination thereof.

When the capacitive power storage unit 56 needs to be charged, a technician can grab the portable power supply 90 and attach the electrodes 230 and 240 of the portable power supply 90 to the electrodes 250 and 260 of the capacitive power storage unit 56, to establish electrical contacts, such that electrical charges are supplied by the portable power supply 210 to the capacitive power storage unit 56.

According to one embodiment of this disclosure, a power supply used to charge the capacitive power storage unit 56 has a unique configuration allowing the use of a low-cost power source with low current output to replenish the capacitive power storage unit 56 at a sufficiently high charging speed. The unique configuration includes a primary power supply having a lower current output, and a secondary power storage device that is charged by the primary power supply and has an output current higher than that of the primary power supply.

For example, as shown in FIG. 6, an exemplary power supply 95 includes a plastic brick power supply 96 as the primary power supply, and one or more ultracapacitors 97, coupled to the plastic brick power supply 96, as the secondary power storage device. The plastic brick power supply 96 is relatively inexpensive, but has a low instantaneous current that cannot charge a capacitive power storage unit 56 at a sufficiently high speed. However, with the configuration of the power supply 95 shown in FIG. 6, the plastic brick power supply 96 constantly charges the ultracapacitors 97 up to a full charge level determined by the physical configuration of the ultracapacitors 97. When the power supply 95 is needed to replenish a capacitive power storage unit 56 of a vehicle service device or system, the power supply 95 is coupled to the capacitive storage unit 56. Since the ultracapacitors 97 has a higher output current than that of the plastic power supply 96, the power stored in the ultracapacitors 97 is dumped to the capacitive storage unit 56 to enable rapid charging, despite the lower output current of the plastic brick power supply 96.

According to another embodiment, the capacitive power storage unit 56 is charged by a power supply in a non-contact manner, such as by inductive charging, magnetic coupling, capacitive coupling, radio-frequency coupling, etc. In one example, each of the capacitive power storage unit 56 and the power supply incorporates a magnetic core surrounded by a coil. The power supply may be implemented using any available technologies, such as an AC source, that could generate alternating magnetic fluxes. When the power supply and the capacitive power storage unit 56 are properly aligned, but without coming into contacts, an alternating current is generated in the coil of the capacitive power storage unit 56 in response to the current flow in the power supply. The alternating current is then rectified into direct current with appropriate rectifying circuits, for charging the capacitive devices included in the capacitive power storage unit 56. Detailed descriptions of non-contact charging circuits and configurations are presented in U.S. Pat. No. 5,536,979, entitled “CHARGER FOR HAND-HELD RECHARGEABLE ELECTRIC APPARATUS WITH SWITCH FOR REDUCED MAGNETIC FIELD,” the disclosure of which is incorporated herein by reference.

According to another embodiment, the same non-contact coupling utilized to charge the capacitive power storage unit is also used for transferring data from or to the capacitive power storage unit or vehicle service device/system. According to still another embodiment, in addition to being powered by a capacitive power storage unit 56, a vehicle service device/system has the capability to draw power from a secondary power source, such an electrical outlet, an additional battery pack incorporated in the devices or systems, etc.

According to a further embodiment, a vehicle service device or system utilizes a capacitive power storage unit as a supplemental or backup power source. The vehicle service device or system includes a primary power source, such as batteries, DC power supply, AC power supply and/or a primary capacitive power storage unit, and uses capacitive power storage units, such as ultracapacitors, as a secondary or supplemental power source to selectively supply instantaneous current to certain circuits, to increase power output when it is needed, and/or to supply power when the primary power source is unavailable. For instance, the alignment head 17 as illustrated in FIG. 2 may include ultracapacitors that are used only to energize LEDs 63 when the LEDs 63 need to be turned on. The ultracapacitors are recharged by the primary power source or an external power supply when the LEDs 63 are turned off.

Variations

Although the above examples use a wheel alignment system for illustrating the concepts of this disclosure, it is understood by people skilled in the art that the concepts may be applied to many types of devices and systems that provide vehicle-related services including, but not limited to, testers for collecting data and/or signals associated with vehicles; devices for providing vehicle-related services, such as multimeters, wiring testers, tachometers, etc.; collision measurement systems; vehicle diagnostic systems; wheel balancers, such as hand-spin or motor-spin balancers and the like; truck balancers; garage management systems; and service tools like screw drivers, drills, grinders, saws, flashlights, impact wrenches, torque wrenches, etc.

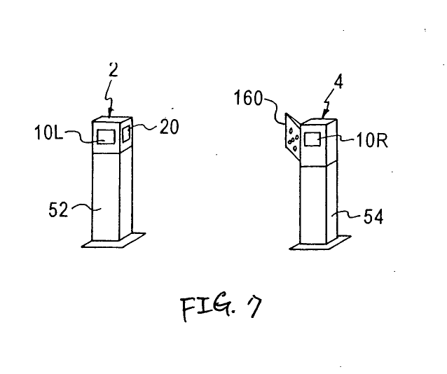

For instance, FIG. 7 depicts another type of alignment system that is powered by a capacitive power storage unit. The alignment system includes a left measurement module 2 and a right measurement module 4. The measurement modules include alignment cameras 10L, 10R for imaging at least one wheel of a vehicle under test or targets attached thereto. The alignment cameras 10L, 10R are supported by a left upright 52 and a right upright 4, respectively. A data processing system (not shown) is coupled to the alignment cameras 10L, 10R wirelessly for processing image data received from the camera modules and determining an alignment status of the vehicle. Detailed structures of image-based alignments systems are described in U.S. Pat. No. 5,724,743, titled “Method and apparatus for determining the alignment of motor vehicle wheels,” and U.S. Pat. No. 5,535,522, titled “Method and apparatus for determining the alignment of motor vehicle wheels,” the entire disclosures of which are incorporated herein by reference. The camera modules are powered by capacitive power storage units as described in this disclosure, in order to provide a cordless system without the disadvantages of using batteries.

According to anther variation, a handheld vehicle diagnostic device, such as Modis™ provided by Snap-on Inc., may use capacitive power storage units as described earlier to supply power needed for the operation of the diagnostic device. The handheld vehicle diagnostic device performs one or more of the following functions: downloading data stored in a vehicle or uploading data to an on-board computer/controller via an on-board data port, such as an OBD-II connector; displaying specifications and/or service-related information to assist performing vehicle services; measuring signals generated by components of a vehicle, such as generator, alternator, spark plugs, batteries, etc.; analyzing exhausts of a vehicle; performing diagnostics; retrieving service-related data from databases; handling garage orders and data; etc. Details of an exemplary handheld vehicle diagnostic device are described in U.S. Pat. No. 6,693,367, entitled “SINGLE-HAND HELD DIAGNOSTIC DISPLAY UNIT;” and in a co-pending U.S. patent application Ser. No. 10/134,690, titled “INTEGRATED DIAGNOSTIC SYSTEM,” the disclosures of which are incorporated herein by reference in their entireties.

According to a variation, a vehicle service unit/system is configured to form a wired or wireless communication link with another device, such as a computer onboard of a vehicle, and the power needed for establishing and/or maintaining the wired or wireless communication link is provided by the capacitive power storage unit.

According to another variation, a vehicle service unit/system is powered by a capacitive power storage unit positioned in, or attached to, the vehicle service unit/system. The capacitive power storage unit is charged when the vehicle service unit/system is connected to another device via a specific type of connectors, such as OBD-II or USB connector, to perform data communications. Examples of vehicle service devices/systems including USB connectors are described in U.S. Pat. No. 6,282,469, entitled “Computerized Automotive Service Equipment Using Multipoint Serial Link Data Transmission Protocols,” the entire disclosure of which is incorporated here in by reference. During operation, the capacitive power storage unit is charged by the connected device via the USB connection.

According to a further variation, a capacitive power storage unit 56 as shown in FIG. 3 is packaged in a way that the capacitive power storage unit 56 and a battery pack can be used interchangeably by a vehicle service device/system. For instance, packages of the capacitive power storage unit 56 and a battery pack should be designed to be able to fit into the same compartment of a vehicle service device/system, such that the capacitive power storage unit can be dropped into the battery compartment to supply power to the vehicle service device/system. Examples of vehicle service devices/systems having a battery compartment are described in U.S. Pat. No. 6,763,594, titled “CORDLESS ALIGNMENT SYSTEM HAVING CONVENIENTLY INTERCHANGEABLE BATTERIES,” the entire disclosure of which is incorporated herein by reference.

In one embodiment, “security keys” are embodied in vehicle service device/system and/or power supplies used to charge the capacitive power storage unit, to ensure that the charging current is provided to the capacitive power storage unit only when a proper coupling is formed between the power supplies and the capacitive power storage unit, to provide better safety in view of the high charging current. The security keys may be implemented using mechanical, electrical, a combination of mechanical and electrical, and/or any other means. For instance, a security key is implemented using a switch that shuts off the charging current unless the power supplies and the capacitive power storage unit are properly connected or coupled.

According to still another variation, indication means is provided to indicate a state of the capacitive power storage units, such as a charge state, power usage, estimated life under current operation status, etc. For example, the indication means may be implemented as a volt meter or a software-implemented charge meter on a display to show the state of charge of a capacitive power storage unit. The capacitive power storage unit may be positioned in a vehicle service device/system, implemented as part of a power supply for replenishing a capacitive power storage unit, a power supply pack including capacitive power storage units, or any types of devices that use capacitive power storage units.

The capacitive power storage unit as described in this disclosure may be replenished using different charging approaches or sources known to people skilled in the art, such has solar power, hydrogen power, electrical power, electromechanical power generation like shaking, cranking devices or energy conversion during a braking or stopping operation. According to one embodiment, a hand-spin wheel balancer is equipped with a generator for charging a capacitive power storage unit that is used to power the balancer. The generator is engaged during a braking or stopping operation to stop the rotation of a wheel, such that the kinetic energy held by the spinning wheel is converted to electrical power by the generator, which in turn charges the capacitive power storage unit. The capacitive power storage unit may be used to power any electrical components or circuits of the wheel balancer. In one embodiment, the power stored in the capacitive power storage unit is used to power a display or to assist spinning or rotation of a wheel under test.

According to another embodiment, the vehicle service device is a type of tools that involves movements when in use. Examples of such type of tools include torque wrenches, screw drivers, impact wrenches, grinders, saws, and so on. Movements or motions in operating the tool charge the capacitive power storage unit of the tool by converting kinetic energy to electrical power by, for example, electromechanical energy conversions or piezoelectric effects. The power stored in the capacitive power storage unit may be used to power electronic components or circuits of the tool, such as displays, LEDs, audio sound, etc.; or to assist operations of the tool, such as enhancing torque or driving force.

In the previous descriptions, numerous specific details are set forth, such as specific materials, structures, processes, etc., in order to provide a thorough understanding of the present disclosure. However, as one having ordinary skill in the art would recognize, the present disclosure can be practiced without resorting to the details specifically set forth. In other instances, well known processing structures have not been described in detail in order not to unnecessarily obscure the present disclosure.

Only the illustrative embodiments of the disclosure and examples of their versatility are shown and described in the present disclosure. It is to be understood that the disclosure is capable of use in various other combinations and environments and is capable of changes or modifications within the scope of the inventive concept as expressed herein.

What is claimed is:

1. A vehicle service device configured to be powered by a capacitive power storage unit positioned in the service device.

2. The device of claim 1, wherein the vehicle service device is an alignment head configured to attach to a wheel of a vehicle to collect wheel parameters, a device configured to download data stored in a vehicle, a device configured to load data to an on-board computer of a vehicle, a device configured to measure signals of a component of a vehicle, a device configured to download data related to vehicle services, or an optical sensor for obtaining optical data associated with at least one wheel of a vehicle, or a non-contact sensor module configured to obtain wheel parameters or vehicle body parameters in a non-contact manner.

3. The vehicle service device of claim 1, wherein the capacitive power storage unit is chargeable by a power supply external to the service device.

4. The vehicle service device of claim 3 further comprising a coupling apparatus for coupling to the power supply for receiving power.

5. The vehicle service device of claim 3, wherein the coupling apparatus is exposed to the external of the vehicle service device.

6. The vehicle service device of claim 3, wherein the capacitive power storage unit is configured to receive power from the power supply in a non-contact manner.

7. The vehicle service device of claim 1, wherein, responsive to the vehicle service device being received by a docking device, an electrical coupling is formed between the vehicle service device and the docking system, for receiving a charging current to charge the capacitive power storage unit.

8. The vehicle service device of claim 7, wherein, responsive to the vehicle service device being received in the docking device, a data channel is formed between the docking device and the vehicle service device for sending data to or receiving data from the vehicle service device via the data channel.

9. The vehicle service device of claim 8, wherein the electrical coupling is used as the data channel.

10. A wheel alignment system comprising:
a vehicle service device configured to obtain alignment parameters of a vehicle;
a capacitive power storage unit configured to power the vehicle service device; and
a data processing system configured to communicate with the service device to receive the obtained alignment parameters and determine a wheel alignment status of the vehicle based on the alignment parameters.

11. The system of claim 10, wherein the service device includes an optical sensor configured to generate the alignment parameters by imaging at least one wheel of the vehicle or a target attached to at least one wheel of the vehicle.

12. The system of claim 10, wherein the service device is attachable to a wheel of the vehicle.

13. The system of claim 10 further including a power supply external to the vehicle service device for charging the capacitive power storage unit of the vehicle service device.

14. The system of claim 13, wherein the capacitive power storage unit is configured to receive power from the power supply in a non-contact manner.

15. The system of claim 13, wherein the vehicle service device includes a coupling apparatus configured to couple to the power supply for receiving power to charge the capacitive power storage unit.

16. The system of claim 13 further comprising a docking device for receiving the vehicle service device or the capacitive power storage unit, wherein the docking device is coupled to a power supply configured to charge the capacitive power storage unit responsive to the vehicle service device or the capacitive power storage unit being received in the docking device.

17. The system of claim 16, wherein, in response to the vehicle service device or the capacitive power storage unit being received in the docking device, a data communication channel is established to access data stored in the vehicle service device or the capacitive power storage unit, or to send data to the vehicle service device or the capacitive power storage unit.

18. The system of claim 17 further including a docking device coupled to a power source and configured to detachably couple to the power supply, wherein the docking device establishes a charging path between the power source and the power supply in response to the power supply being coupled to the docking device.

19. A vehicle service system comprising:
sensing means for obtaining spatial parameters associated with a vehicle, wherein the sensing means is powered by a capacitive power storage means incorporated in the sensing means; and
data processing means for receiving the obtained spatial parameters from the sensing means and for determining spatial characteristics of the vehicle based on the received spatial parameters.

20. The system of claim 19, wherein the determined spatial characteristics are related to a wheel alignment status or a vehicle body alignment status.
